(19) United States
(12) Patent Application Publication
(10) Pub. No.: US 2011/0311785 A1
(43) Pub. Date: Dec. 22, 2011

(54) SYSTEM AND METHOD FOR DISPLAYS

(76) Inventor: Matthew Carl O'Malley, Lake Balboa, CA (US)

(21) Appl. No.: 13/164,771

(22) Filed: Jun. 20, 2011

Related U.S. Application Data
(60) Provisional application No. 61/356,545, filed on Jun. 18, 2010.
(60) Provisional application No. 61/356,545, filed on Jun. 18, 2010.

(51) Int. Cl. B32B 3/00; A44B 11/02

(52) U.S. Cl. 428/189; 24/68 R

(57) ABSTRACT

A system and method for creating displays, ornamentation, and connectors. Including displays, signage, ornaments, and connectors, that can easily be modified and manipulated to create different appearances and/or functions quickly and easily.

Benefit and Reference to Prior Provisional Application under 37 CFR 1.76

This non-provisional application claims the benefit under 35 U.S.C. 119(c) and 37 CFR 1.79 of a prior provisional application filed within the previous twelve months as U.S. Provisional Application No. 61/356,545, filed Jun. 18, 2010, by inventor Matt O'Malley.

Benefit and Reference to Prior Provisional Application under 35 USC 119(e)

Per above, this non-provisional application claims the benefit of U.S. Provisional Application No. 61/356,545, filed Jun. 18, 2010, by inventor Matt O'Malley.

### BACKGROUND

Field of the Invention

The field of the present inventions relates to ornaments and displays; more specifically, easily modifiable and/or interchangeable, displays, signage, and ornaments.

### SUMMARY OF THE INVENTION

All U.S. Patents listed below and throughout are herein entirely incorporated by reference. Further, referenced throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in another embodiment,” and similar language throughout this specification may, but do not necessarily, all refer to the same embodiment. Many modifications and variations will be apparent to the practitioner skilled in the art.

Also referenced throughout this specification are the terms and/or phrases such as “for example,” “for instance,” “say,” “the like,” “etc.,” or similar language which generally means that the language, description, and explanation utilized in association is merely to demonstrate an clement, feature, item, list of items, purpose, Way, means, method, and/or the like for what has been described in association, but depending on the usage and situation, it may not be meant to be exhaustive representation or demonstration, or meant to limit the invention to that particular precise formation.

Further, referenced throughout this specification are also the terms and/or phrases such as “unit,” “section,” “part,” “portion,” “element,” “entity,” “component,” “article,” or similar language which generally means that a described term and/or phrase in connection thereof constitutes a separate distinct “article”, “feature,” “structure.” “characteristic,” “trait,” or similar of an embodiment of the present invention. In some embodiments, terms such as “unit,” “section,” “part,” “portion.” “element.” “entity,” “component” “article,” or similar language may be interchangeable.

Furthermore, referenced throughout this specification are also the terms and/or phrases such as “units,” “sections,” “portions,” “elements,” “entities,” “components,” “articles,” “traits,” “characteristics,” “group(s),” “selection(s),” composite(s),” “compilation,” or similar language which generally means that a described term and/or phrase in connection and/or the combination thereof constitutes also a separate distinct “article”, “feature,” “structure,” “characteristic,” “trait,” or similar of an embodiment of the present invention.

In expensive displays, signage and/or ornaments arc typically either hand created, printed on a home or business printer, or done professional and purchased. Displays, signage and ornamentation done by hand can be time consuming, difficult to reproduce quickly and/or accurately, and/or may appear unprofessional, illegible, and/or cheap. Displays, signage and ornamentation that are done by a home or business printer typically are done on a common-sized 8½×11 inch standard sheet of paper, thus limiting the end presentation size and/or impact of the final product. Further, paper lacks the rigidity often required for signage and does not lend itself for long term use, especially not when exposed to outdoor weather.

Displays, signage, and ornamentation done professionally can be relatively more expensive and is typically created on permanent materials that then lack the ability to be modified and/or reused later. For instance, a yard sign printed on a sign with an arrow pointed in a particular direction can be difficult or impossible to modify after printing.

What is needed is a system that is flexible to the current needs of the user (e.g. the display, signage, or ornament creator, and/or the display, signage, or ornament displayer/presenter) wherein something as simple as a printed sheet of paper can relatively quickly and easily become a professional looking display, signage or ornament that provides a function, such as a navigation aid (e.g. arrow) or become an ornamentation, such as a piece of artwork.

The invention allows for materials printed on a standard sheet of paper to be enhanced by a variety of methods that can be modified relatively easily and quickly, as needed. For instance, an 8½×11 inch sheet of common letter sized paper can be inserted into a decorative and/or a function frame and/or a sleeve design that, say, has an arrow pointing in a particular direction, and further, can be easily transposed and/or permanently sealed/laminated if desired.

For instances, the display/signage system can be made of a channeling system that allows for the center piece, such as a piece of paper, paper covered by glass, card stock, foam core, wood, steel, plastic, plexiglass, and/or the like.

The invention allows a user to easily create a display/signage system comprising of a perimeter decorative shape (e.g. arrow, star, rectangle, triangle, oval, and the like) that can also provide navigation, such as an arrow, and/or can include a window for displaying a center piece attached to the perimeter decorative shape, wherein the centerpiece is interchangeable.

The perimeter decorative shape can be of a variety of recognizable shapes, such as a vehicle shape (e.g. car, truck, motorcycle, boat, bike, and the like), a sporting shape (e.g. football, baseball, basketball, racecar, hockey stick, tennis rack, golf club, soccer ball, ski, and the like), a geographic shape (e.g. a county, waterway, street sign, landmark, college abbreviation, and the like), a person shape (e.g. man, woman, a particular athlete, a particular singer, a particular actor, a particular comedian, a particular politician, a particular model, a particular villain, a particular celebrity, a particular profession, and the like), and/or an at least one letter or a plurality of letters (e.g. someone's initials, some event (i.e. birthday), some set of numbers, some word, and the like).

Parts of the display/signage/ornament, such as the face inside the perimeter decorative shape can be printed with such things that can be identifiable markings, such as a person's face, a place, a thing, and/or a combination of things. Parts of the display/signage/ornament can allow for user decorations.

### BRIEF DESCRIPTION OF THE FIGURES

A better understanding of this invention will be had by referring to the embodiments in the accompanying drawings in which:

FIG. 1 depicts an embodiment wherein a display/sign can be created by folding together two sides around an at least one sheet of paper 104a.

FIG. 2 depicts an embodiment where the two sides have been brought together around the line 191 to encapsulate the paper 104a.

FIG. 3 is an exploded perspective view depicting an embodiment where the paper 104a can be lined up between the two unconnected sides.

FIG. 4 depicts an embodiment wherein a top channel 110 with a hanger 111 is attached on the top of a particular arrow shaped display/sign 109 (per the down arrows shown) to thus sandwich the center piece.

FIG. 5 depicts an embodiment wherein the display/signage 109 has the top channel 110 and the bottom channel 112 attached.

FIG. 6 depicts an embodiment wherein the overall display/sign can be assembled by the user to create a perimeter shape.

FIG. 7 depicts an embodiment wherein the assembled perimeter shape (without framing channels 110/112 attached) creates an arrow shape.

FIG. 8 is a perspective view that depicts an embodiment of the connecting means 305 wherein the connector is a “H” type clip that could be utilized.

FIG. 9 is a top view of the “H” clip 305 connector that can connect the assembled components/parts and depicts the centerpiece 104 before it is inserted into the “H” clip 305 connector.

FIG. 10 depicts an embodiment wherein a user assembled display/sign has a pre-established perimeter 304 shape, an arrow in this instance.

FIG. 11 depicts an embodiment of a corner holder 306 that could be utilized by a user in the assembly of the pre-established perimeter 304 shaped display/sign in FIG. 10.

FIG. 12 depicts an embodiment wherein the paper 104a can be inserted into a particular type of single-sided piece 130 of material without any window.

FIG. 13 depicts an embodiment wherein the paper 104a is attached from behind to a particular type of single-sided piece 132 of material, but with a window 133 cutout for showing the paper 104a.

FIG. 14 depicts an embodiment wherein the display/signage perimeter shape is a star shape 161.

FIG. 15 depicts an embodiment wherein the center piece, e.g. the paper 104a, is sandwiched between two sides of material to create a star shaped 164 ornament and/or display/sign with a window cutout for showing the paper 104a.

FIG. 16 depicts an embodiment wherein the display/signage perimeter shape is a football shape.

FIG. 17 depicts an embodiment wherein the center piece, e.g. the paper 104a, is sandwiched between two sides of material to create the football shape 142 ornament and/or display/sign with a window 143 cutout for showing the material/paper 104a.

FIG. 18 is a perspective view of an embodiment of a display/sign with a three-dimensional shape 183 that could be constructed of, say, plastic and sealed off to protect the item inside, or there could be a method of removing the item, such as a hinged door.

FIG. 19 is a perspective view of an embodiment of the display/sign with a three-dimensional shape with an opening 184, say, at the top, for allowing access to such things a pamphlet, flyer, business card, pen, pencil, and the like.

FIG. 20 depicts an another embodiment wherein a laminated 180 display/sign and/or ornament can be created by sandwiching the center piece 181, such as the paper 104a, wherein the laminated 180 display/sign can be made of two adhesive sides that come together with and/or without a heat sealer.

FIG. 21 depicts a particular windowed 170 display/sign and/or ornament that includes a window-material 171 that can be made of a particular material that can be tinted, such as a cellophane, wherein the print and/or artwork on the underlying paper 104a is still legible.

FIG. 22 depicts another embodiment of the frame 202 system that allows for an inserted material for creating a particular arrow display/sign.

FIG. 23 depicts the same frame 202 system wherein the paper 104a has been partially inserted into the channel.

FIG. 24 depicts a perspective view of the frame 202 system from behind.

FIG. 25 depicts the frame 202 system with the backdoor 201 cap swung down/closed.

FIG. 26a depicts an embodiment of a component of a particular “Strap-Lock ‘H’ connector” 450 called a “H-side body” 400 which may be considered the front.

FIG. 26b depicts an embodiment of the same “H-side body” 400 component, but from which may be considered the top or bottom surfaces.

FIG. 26c depicts another component of the particular “Strap-Lock ‘H’ connector” 450 called a “H-Strap” 460 from which may be considered a side view.

FIG. 26d depicts an embodiment of the same “H-Strap” 460, but as a cross section down the center from which may be considered a top view.

FIG. 26e depicts an embodiment of the same “H-side body” 400 component in FIGS. 26a and 26b, but as a cross section down the center from which may be considered a top view.

FIG. 26f depicts an embodiment of a pair of the same “H-side body” 400 components, with a top one 400a and a bottom one 400b.

FIG. 26g is a perspective view that depicts the pawls that oppose each other and the strap is arranged to be reversely flexed and inserted through the head from a bottom upward direction in FIG. 26f.

FIG. 27a depicts a perspective view of another embodiment of another particular “Strap-n-Tie ‘H’ connector” 550 which is similar to the “Strap-Lock ‘H’ connector” 450.

FIG. 27b depicts the “Strap-n-Tie ‘H’ connector” 550 also uses the same “H-side body” 400 component

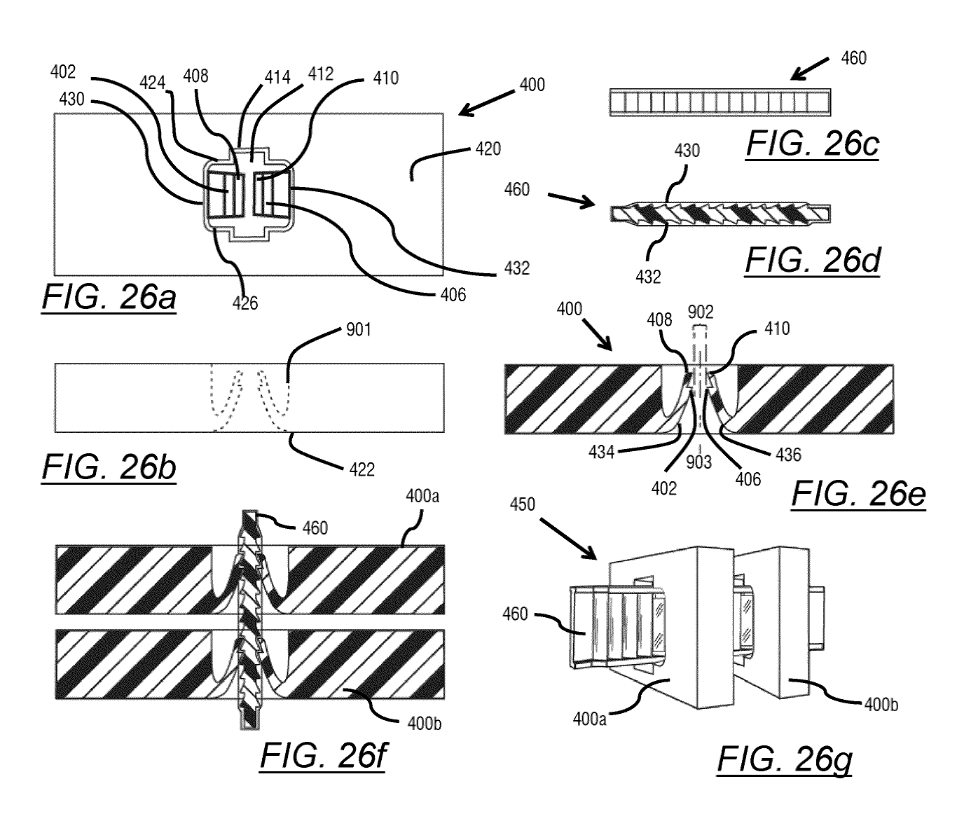

FIG. 26c depicts the same “Strap-n-Tie ‘H’ side body 500 from which may be considered a side view.

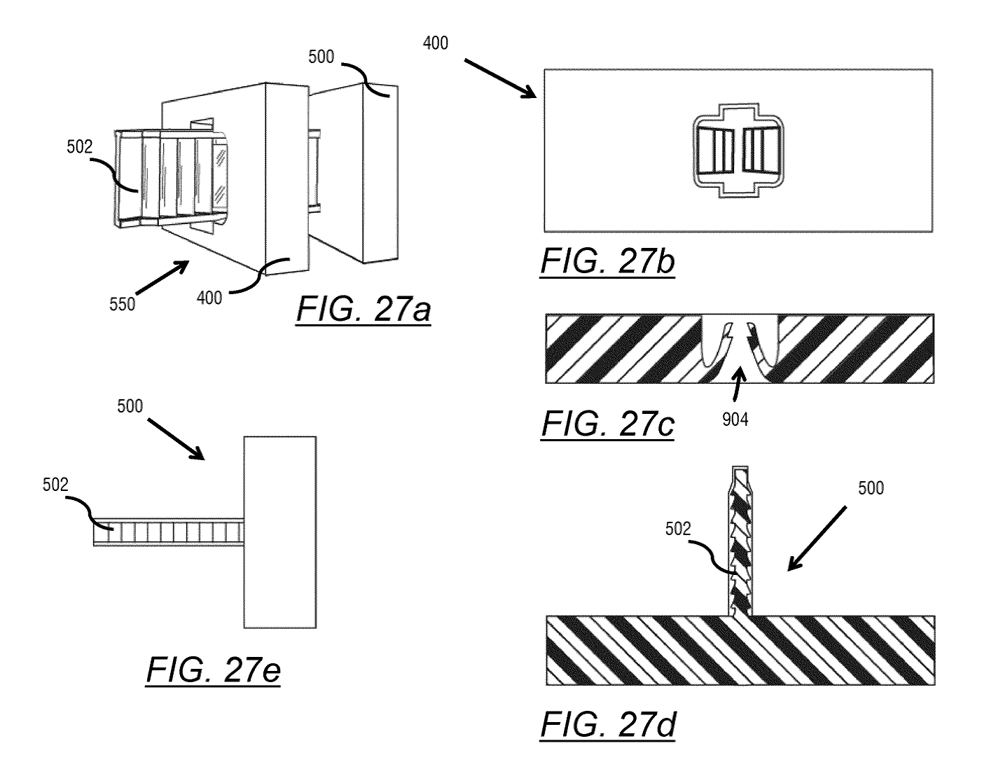

FIG. 27d depicts an embodiment of a “Strap-n-Tie ‘H’ side body 500 which is similar to the “H-side body” 400, but also has a strap molded and/or adhered, similar to the H-strap 460 and as depicted with a cross section down the center from which may be considered a top view.

### DETAILED DESCRIPTION OF THE INVENTION

Referring first to a FIG. 1 that depicts an embodiment wherein a display/sign can be created by folding together two sides around an at least one sheet of paper 104a. A side 101 is folded back against a side 102 along a line 191 thus encapsulating a center piece 104 (e.g. a standard sheet of paper, sometimes referred to as the paper 104a, and in some embodiments utilized interchangeably), behind a cutout a window 190 that allows the printed material to be read on the paper 104a through the cutout window. The display/sign and the window 190 could be created from a standard 8½×11 sheet of paper 104a, but could also be created for any size and/or shape of material, and thus the window 190 shape doesn't have to be rectangle.

A pair of distinct sides, the side 101 and the side 102, can be one solid piece of material and made from the same material, and/or the pair of distinct sides can be fabricated together. The pair of distinct sides, sides 101 and 102 could be made of different materials and two separate pieces, and/or fabricated together, so that the hinge along the line 191.

The materials to construct the pair of distinct sides can be any material appropriate for making the display/signage or ornament, such as paper, plastic, foam core, metal, wood, cloth, glass, plexiglass, cellophane, foam, rubber, Styrofoam, and does not necessarily have to be rigid, unless rigidity was desired by the user. For instance, the ornament may be utilized in conjunction with another element, such as a collage, a quilt, and/or a hanging mobile.

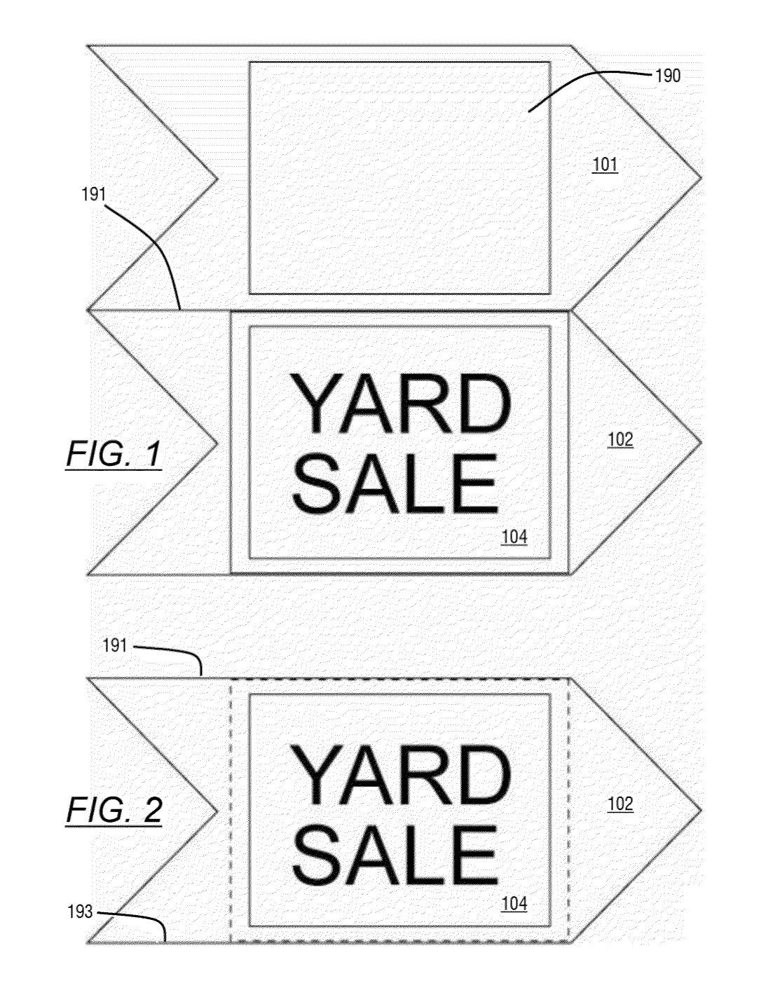

FIG. 2 depicts an embodiment where the pair of distinct sides have been brought together around the line 191 to encapsulate the center-piece 104 (e.g. paper 104a). The pair of distinct sides can be connected along a bottom 193 to create a relatively flat display/sign or instead allowed to fan out to create a support base and thus allowing the user to stand the display/sign upon a surface.

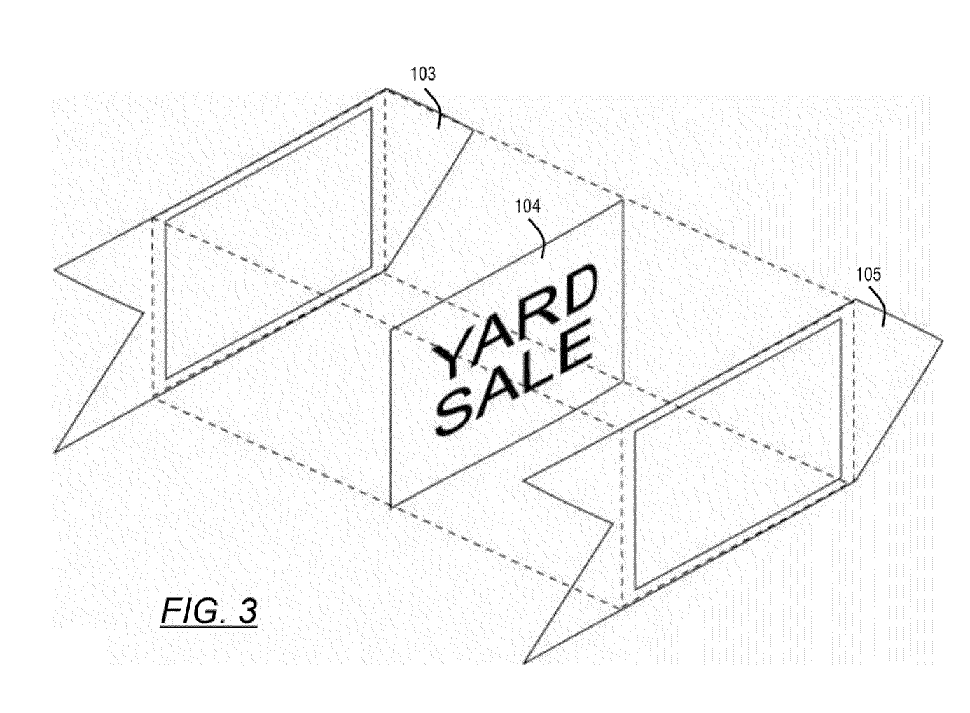

FIG. 3 is an exploded perspective view depicting an embodiment where the paper 104a can be lined up between a pair of separate sides. In this embodiment, a side 103 and a side 105 are two separate materials that come together to sandwich the center piece 104, say, the paper 104a. In addition, there can be more than one piece of paper 104a, say another sheet facing the other direction (not visible in FIG. 3). The pair of separate sides, the side 103 and the side 105 sandwich the center piece (e.g. paper 104a) and can be temporarily connected through a variety of means and/or permanently attached. For instance, if temporarily connected the pair of separate sides could be fasten together utilizing a variety of means such as Velcro, an adhesive that may or may not be permanent, shrink wrapped, stapled, clipped, pinned, taped, screwed, nailed, interlocking, and/or some combination of means.

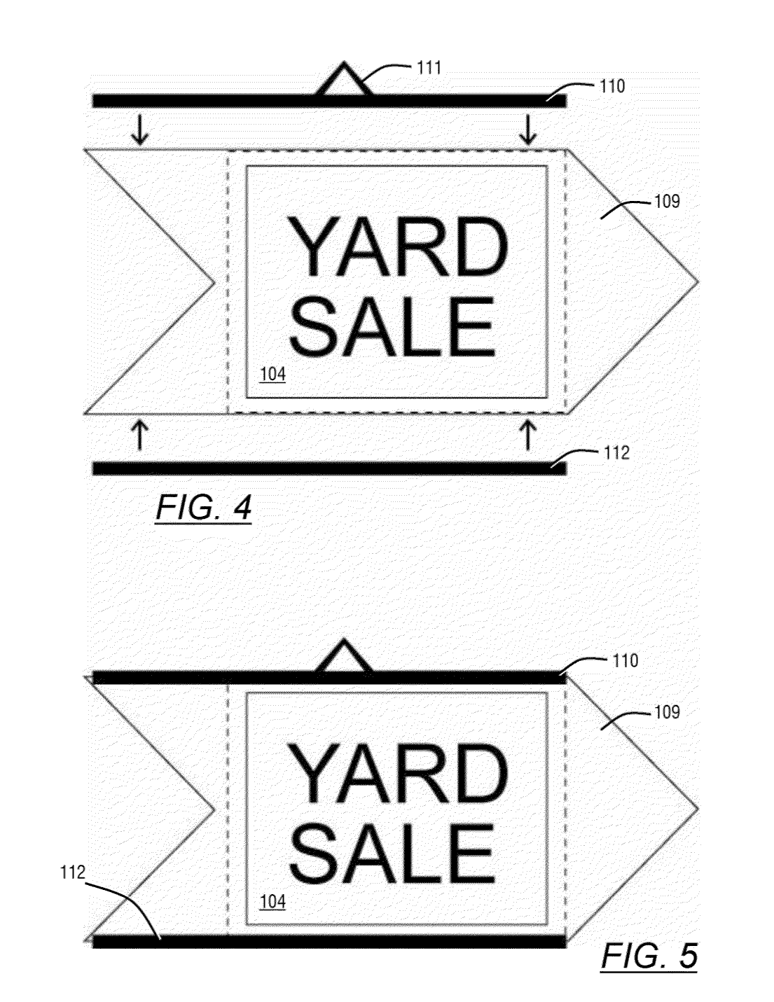

FIG. 4 depicts an embodiment wherein a top channel 110 with a hanger means 111, here a hanger 111a which is attached on the top of a particular arrow shaped display/sign 109 (per a pair down arrows with arrowheads shown) to thus sandwich the center piece 104. A bottom channel 112 can be attached, if desired and/or required (per a pair up arrows with arrowheads shown). Channels can be attached to any side/perimeter, including the particular arrow shaped display/sign 109 arrowhead and/or tail. Further, each channel be can be an individual piece and could come pre-connected (not shown in FIG. 4).

FIG. 5 depicts an embodiment wherein the display/signage 109 has the top channel 110 and the bottom channel 112 attached. The top channel 110 and the bottom channel 112 can be used to add rigidity and allow for the user to relatively easily modify the display/signage 109 without having to permanently attaching the two separate sides together. The hanger means 111 can come in a variety of shapes and materials and there can be a plurality of hangers, as desired, say, two at opposite ends (not shown in FIG. 5). The hanger means 111 can be removable, scalable, telescope-longer or taller, and/or collapsible. It could also be made to slide along the top channel (or any channel) as needed.

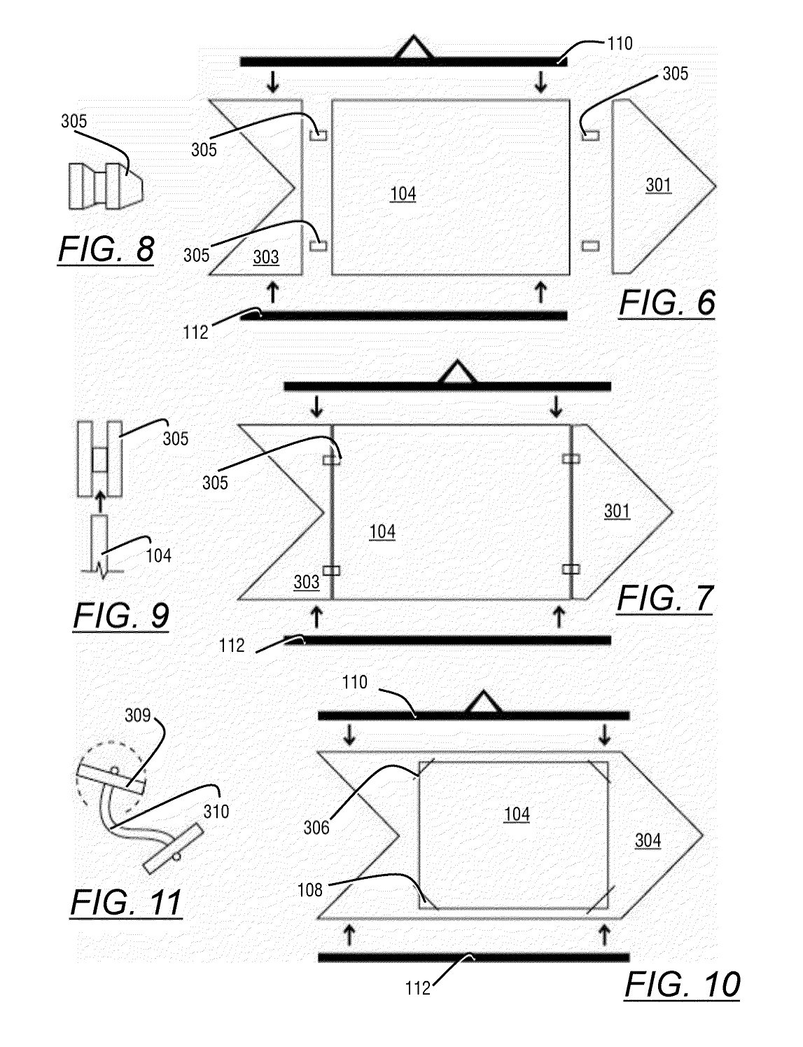

FIG. 6 depicts an embodiment wherein a particular overall display/sign can be assembled by the user to create a perimeter shape. FIG. 7 depicts an embodiment wherein an assembled perimeter shape (but without the framing channels 110/112 attached) via a connection means 305 creates an arrow shape. An arrowhead 301 part that in this instance has been previously die-cut this particular shape and is connected to a particular centerpiece 104 (e.g. a piece of paper 104a, foam core, wood, or the like). The centerpiece 104 is also connected to an arrow-fin 303 that in this instance has been previously die-cut this particular shape. In this embodiment, the particular connection means 305 is a “H” type clip 305a that can ideally be reused.

Further and ideally, where ideally the connection means 305 doesn't visually distract from the display/signage intended purpose and/or presentation. Once the sign has been assembled with the “H” type clip 305a, the user can also attach the top channel 110 and the bottom channel 112 to provide the hanging means 111, to also add structurally support, and/or improve the rigidity. However, the top channel 110 and the bottom channel 112 are not required for completing the overall display/sign.

FIG. 8 is a perspective view that depicts an embodiment of the connecting means 305 wherein the connecting means is the “H” type clip 305a that could be utilized to interconnect and assemble the parts 301, 104, and 303. FIG. 9 is atop view of the same “H” clip 305a connector that can be utilized for the connection means 305 and the assembling the components/parts as depicts the truncated view of the centerpiece 104 before it is inserted into the “H” clip 305 connector. The “H” type clip 305a ideally creates a pressure type connection to the articles it connects to on both sides, where the “H” type clip 305a could have a pair of inside dimensions that are the same on both sides of the “H” type clip or the pair of inside dimensions could be different, where one particular inside dimension could be wider to, say pressure connect to a particular thickness of a foam-core thickness, and where the opposite inside dimension could be narrower to, say pressure connect to a particular thinness of a sheet of paper thinness.

In another embodiment, a particular “H” type clip has a pair of adjustable inside dimensions on the “H” type clip that could be independently adjusted and/or compressed to allow for a range of thickness from, say a relatively thick stock of foam-core to, say a relatively thin sheet of paper (not shown in FIGS. 6-11). In another embodiment, the pair of adjustable inside dimensions on the “H” type clip that could be independently adjusted and/or compressed to allow for a range of thickness could be independently hinged creating a pressure clamp connection (not shown in FIGS. 6-11).

FIG. 10 depicts an embodiment wherein the display/sign has a pre-established all-in-one perimeter 304 shape, in this instance, an arrow. Each corner 108 of the center piece 104 can be held in place by a corner holder 306. FIG. 11 depicts an embodiment of the corner holder 306 that could be utilized by the user in the assembly of the pre-established perimeter 304 shaped display/sign in FIG. 10. For instances, in one embodiment the corner holder 306 could be an elastic band 310 material, say ½ inch in length when in it's relaxed position, with an end clip 309 on both ends wherein the user could press each end clip 309 through a hole knocked out (not shown) from the front of the unit 304 along the edge of the paper 104a and near a corner of the paper all the way through the unit 304.

The user could pre-drill a hole or simply press the end clip 309 of the elastic band 310 firmly through the unit 304 (say, wherein a particular unit 304 was made of a relatively easy penetrate-able material, such as foam core) and/or insert the end clip 309 all the way through the unit 304 in a strategic location without utilizing any knockout when the user had, say a random sized centerpiece 104.

After the end clip 309 was completely inserted, it would lock against the back of the unit 304 and then the user would insert the end clip 309 on the other end of the elastic band 310 material in a strategic location that captures the corner of the centerpiece 104 (e.g. paper 104a in FIG. 10) and presses the end clip 309 all the way through the unit 304 to allow it to be captured when pivoted along a connection to the elastic band 310 (see a dotted line in FIG. 11) on the backside of the unit 304. These steps arc repeated for each corner and/or for each location the user wants to anchor the paper 104a and/or other items to the unit 304. For instance, the user may wish to also, or instead anchor decorative items, such as a bell, bow, ribbon, streamer, and the like and/or functional items, such as a sign-up pen, a holder for a pen, a business card holder, a flyer holder, and the like, with an at least one elastic band (not shown). In some embodiments the elastic band 310 would have the end clip 309 at one end, but a connection means at the other end, for holding, say the sign-up pen.

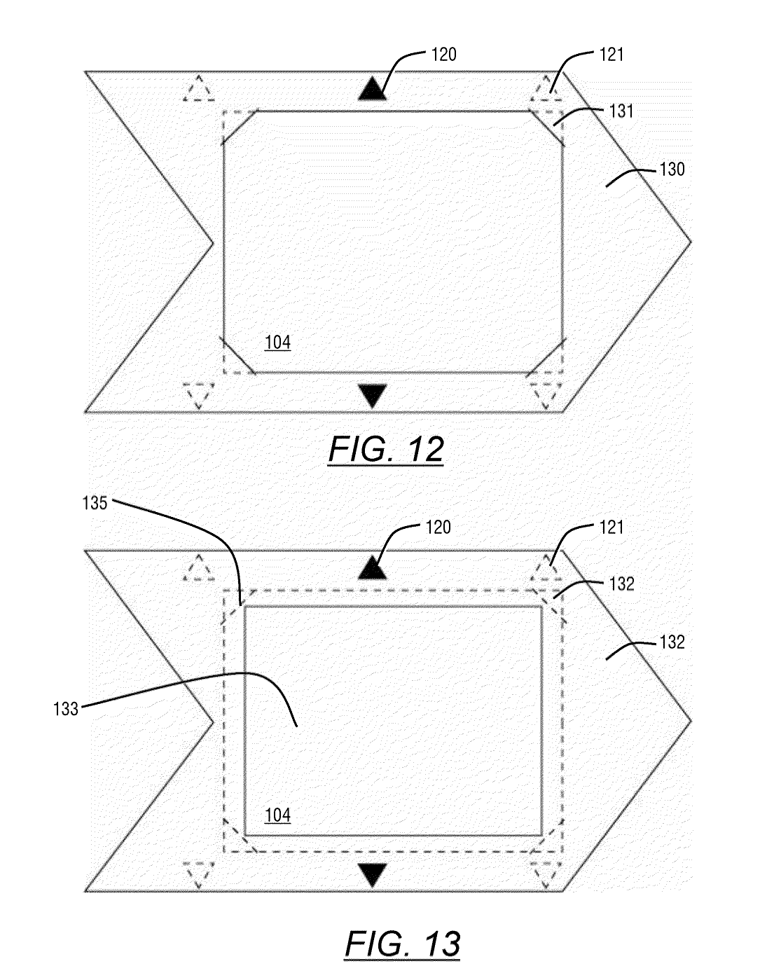

FIG. 12 depicts an embodiment wherein the centerpiece 104 (e.g. the paper 104a) can be inserted into a particular type of single-sided piece 130 of material without any window. A corner 131 of the paper 104a can be tucked into a diagonal opening to create the finished arrow display/sign in this embodiment. Furthermore, the display/sign 130 can have several sized slits and/or slits in a range of locations allowing for a variety of paper sizes. in addition, the user could create his/her own slits as needed for a special size sheet of paper 104a. A knockout 120 (depicted as a black triangle and as removed) allows for the unit/display/sign 130 to be hung and the knockout 120 was knocked out from a perforated plug 121, so that the user can select which of the perforated plugs 121 he/she wants to remove for hanging and/or some other purpose (say, connecting to other ornaments).

FIG. 13 depicts an embodiment wherein the paper 104a is attached from behind to a particular type of single-sided piece 132 of material, but with a window 133 cutout for showing the paper 104a. Corners 132 of the paper 104a are tucked into corner holders 135 on that are attached to backside of the single-sided piece 132 of material. These corner holders 135 can come permanently attached to the backside of the unit/display/sign 132 to allow for a set size and thickness of material to be inserted, e.g. the paper 104a, or these corner holders 135 can be adjustable and/or attachable by the user, thus allowing for a range of insert sizes.

For instances and similar to FIGS. 10 and 11, in one embodiment the corner holder 135 could be an elastic band material, say ½ inch long in the relaxed position, with a clip on both ends wherein the user could press each clip through a hole knocked out (not shown) from the front of the unit 132 along the edge of the paper 104a and near a corner of the paper all the way through the unit 132 and securing the centerpiece 104 corner. These steps arc repeated for each corner and/or for each location the user wants to anchor the paper 104a and/or other items to the unit 132.

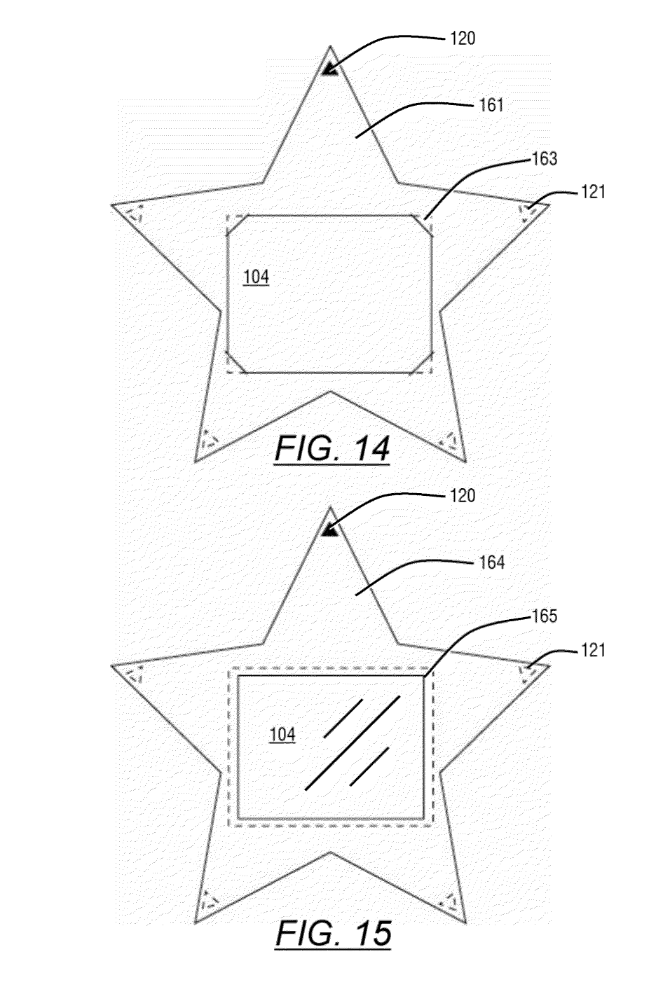

FIG. 14 depicts an embodiment wherein the display/signage perimeter shape is a star shape 161. Similar to FIG. 12, the paper 104a can be inserted into a particular type of single sided piece/unit 161 of material without any window. A corner 163 of the paper 104a is tucked into diagonal opening, and/or using the corner hangers to create the finished star shape, by repeating for each of the other corners 163. Furthermore, the display/sign can have several sized slits for a variety of paper sizes and/or the user could create his/her own slits as needed for a special size sheet of paper 104a. The star unit 161 can also be made to securely hold other functional items, such as mirror, dry erase board, chalk board, clock, computer screen, TV, photo, and the like. In these embodiments with materials that are heavier than paper, the overall unit would need to be constructed in accordance with the anticipated function and materials being held.

FIG. 15 depicts an embodiment wherein the center piece, e.g. the paper 104a, is sandwiched between two sides of material to create a star shaped 164 ornament and/or display/sign with a window 165 cutout for showing the paper 104a. Similar to FIG. 14, FIG. 15 has the knockout 120 (removed) that allows for the unit to hung and the knockout 120 was knocked out from the perforated plug 121, so that the user can select which of the perforated plugs 121 he/she wants to remove for hanging and/or some other purpose. The star unit 164 can also be made to be a name badge and have an attachment means applied to the back, such as pin, clasp, hook, snap, Velcro, tape, wire, and/or the like (not shown).

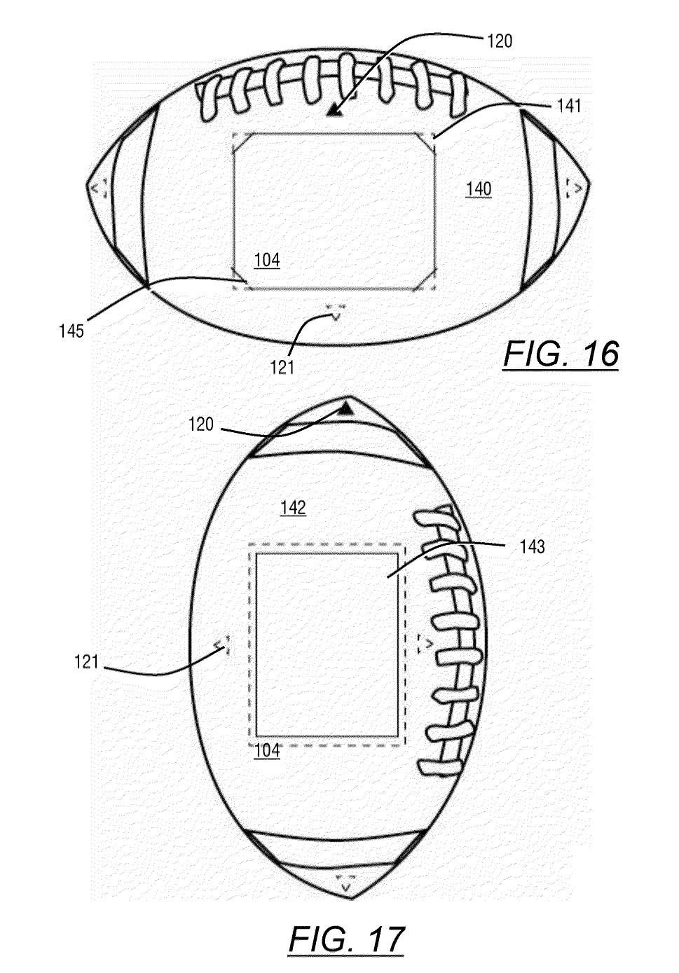

FIG. 16 depicts an embodiment wherein the display/signage perimeter shape is a football shape. Similar to FIG. 14, the center piece (e.g. paper) 104 can be inserted into a particular type of single-sided piece 140 of material without any window. Corners 141 of the paper 104a are tucked into diagonal openings or slits 145 and/or attached by corner hangers to create the finished ornament. Furthermore, the display/sign can have several size slits for a variety of material sizes and/or the user could create his/her own slits 145 as needed for a special size materials, e.g. sheets of paper 104a, photos, awards, newspaper clippings, and the like.

FIG. 17 depicts an embodiment wherein the center piece, e.g. the paper 104a, is sandwiched between two sides of material to create the football shape 142 ornament and/or display/sign with a window 143 cutout for showing the material/paper 104a (should be over centerpiece). Similar to FIG. 16, FIG. 17 has the knockout 120 (removed) that allows for the unit to hung and the knockout 120 was knocked out from the perforated plug 121, so that the user can select which of the perforated plugs 121 he/she wants to remove for hanging and/or some other purpose. For instances, rotating the football shape 142 to utilize the shape in portrait mode instead of the landscape mode depicted in FIG. 16.

In one embodiment, the window 143 is not only a cutout, but also has a piece of transparent material that protrudes outward, such as plastic bubble shape, thus allowing the user to mount objects that are not flat, such as a piece of three-dimensional artwork, sculpture, award, and the like, and may or may not allow for the item to be removed by viewers (example, FIG. 19).

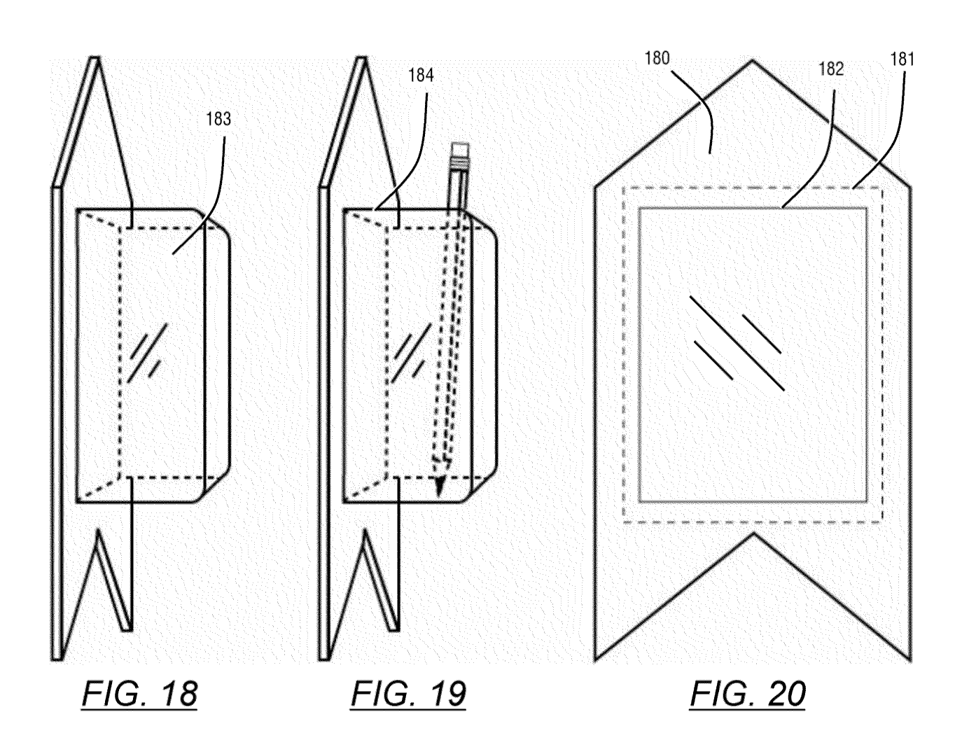

FIG. 18 is a perspective view of an embodiment of a display/sign with a three-dimensional shape 183 that could be constructed of, say, plastic and sealed off to protect the item inside, or there could be a method of removing the item, such as a hinged door (not shown).

FIG. 19 is a perspective view of an embodiment of the display/sign with a three-dimensional shape with an opening 184, say, at the top, for allowing access to such things a pamphlet, flyer, business card, pen, pencil, and the like.

FIG. 20 depicts an another embodiment wherein a laminated 180 display/sign and/or ornament can be created by sandwiching the center piece 181, such as the paper 104a, wherein the laminated 180 display/sign can be made of two adhesive sides that come together with and/or without a heat sealer. In all of these embodiments with materials that arc heavier than paper, the overall unit would need to be constructed in accordance with the anticipated function and materials being held.

In one embodiment, the two laminated sides are fully or mostly transparent and there can be guidelines that are either temporarily or barely visible for helping the user place in the paper 104a. The two laminated sides can be all one piece of material that is hinged together; two pieces fabricated together, or two separate pieces of material that sandwich together. Each laminated 180 display/sign could have patterns and/or designs that are cosmetic and/or functional for placing the paper 104a inside. For instances, one side of the laminated 180 display/sign could be orange, and the other side could be orange, except for an area 182 that was clear (not tinted) for showing the paper 104a through.

In one embodiment, the transparent window area 182 could come preprinted with words, such as “Yard Sale”, “Happy Birthday”, and the like, wherein the user does not have to modify and/or can add elements/text as needed. In another embodiment, the laminated 180 display/sign/unit can come with a number of pre-printed center pieces 104 that can be utilized individually and/or combined to create the finished unit.

The two laminated sides, as in other embodiments listed, can conic be created to hold a variety of sizes of materials (e.g. standard paper, legal, and the like), a variety of thicknesses (e.g. paper, foam core, and the like), come in a variety of colors, come in a variety of mil-thicknesses, a variety of window shapes (e.g. rectangle, round, oval, triangular, stars, arrows, and the like) and/or a variety of outline shapes (e.g. rectangle, round, oval, triangular, stars, arrows, and the like). The materials can come pre-printed.

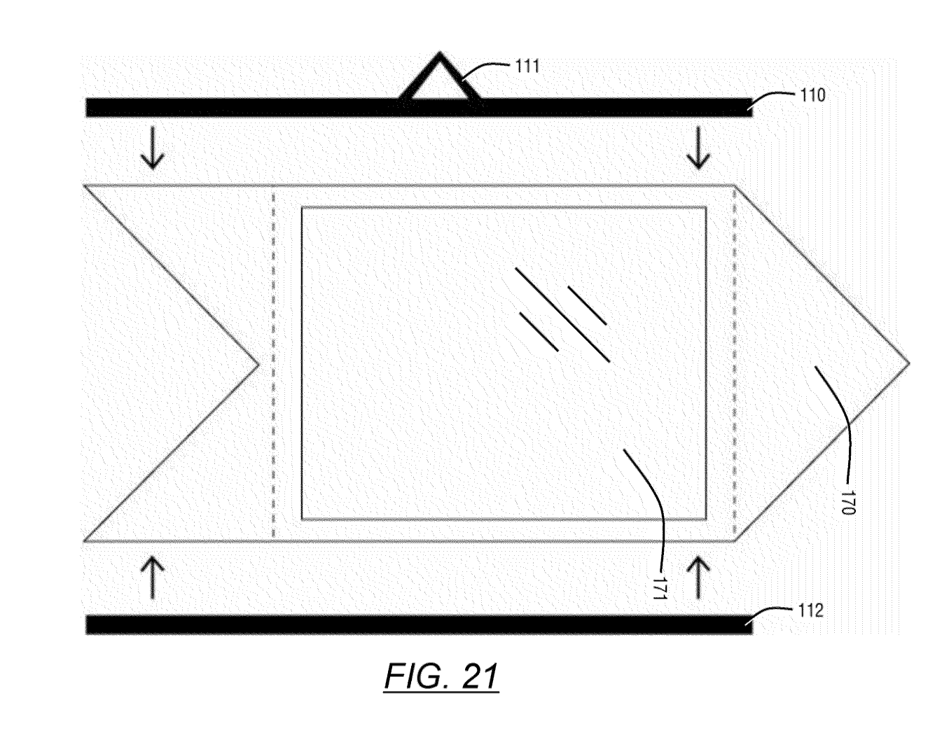

FIG. 21 depicts a particular windowed 170 display/sign and/or ornament that includes a window-material 171 that can be made of a particular material that can be tinted, such as a cellophane, wherein the print and/or artwork on the underlying paper 104a is still legible. For instance, the windowed 170 display/sign can be made of a particular color, say, lime green, and where in the window-material 171 is a lime green tinted sheet of cellophane. This allows the user to quickly create eve-catching colored display/signs from easily printed display/signs of black letters and/or shapes on a white sheet of paper. In addition, the window 171 could be a pre-formed in a shape other than flat to attraction attention and/or hold items.

The window can also help protect the underlying paper and/or artwork from damage and/or other wear and tear. This windowed 170 display/sign can also be a variety of other perimeter shapes, perimeter shaped windows, three-dimensional windows, and can be made to temporarily or permanently sealed together the items inside (e.g. paper 104a, artwork, and the like). The display/sign/ornament 170 could also be stabilized and/or made more functional by adding channels to the perimeter, such as the top channel 110 with the hanger 111 and the bottom channel 112. The top channel 110 can obviously be switched/replaced for the bottom channel 112, vice versa, and the display/sign/ornament can be rotated, as desired, by the user.

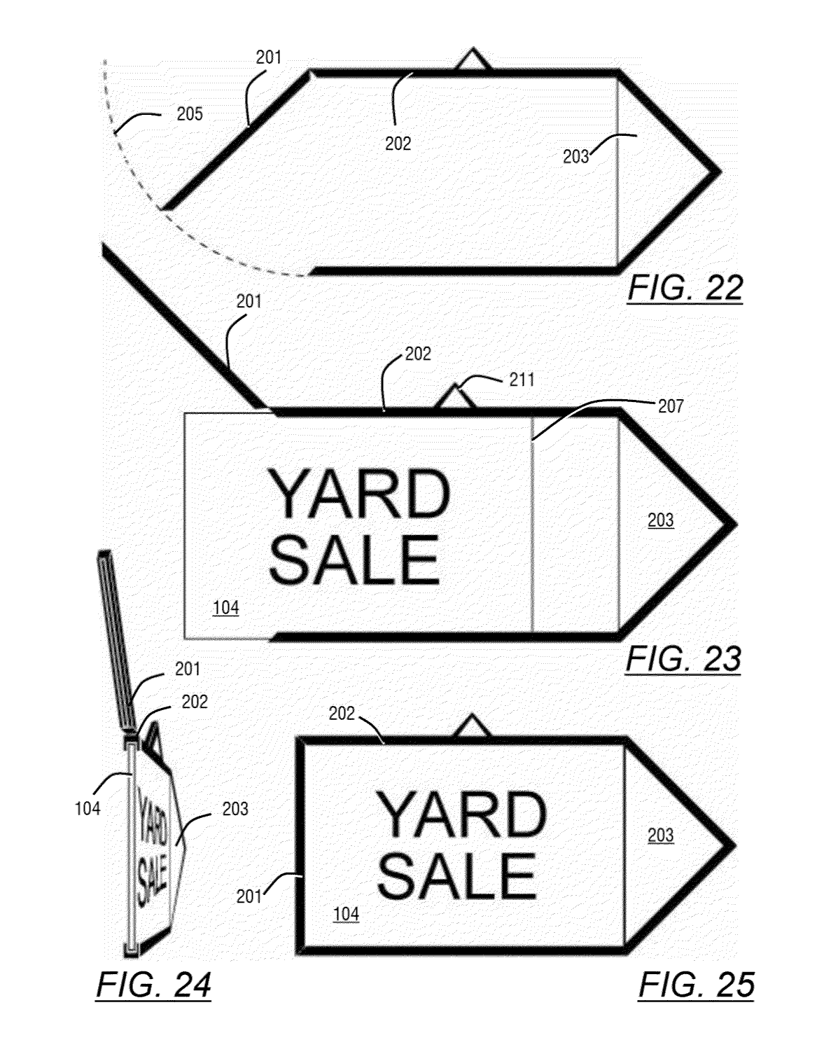

FIG. 22 depicts another embodiment of the frame 202 system that allows for an inserted material for creating a particular arrow display/sign. An arrowhead 203 shape can be made of card stock and come in a variety of shapes, materials, and colors that can be inserted inside the channel. A backdoor 201 cap can be hinged to the frame 202 or snapped into place after the paper 104a is inserted/later. A dotted line 205 depicts the path the backdoor could have, if the backdoor 201 cap is hinged from the top side.

FIG. 23 depicts the same frame 202 system wherein the paper 104a has been partially inserted into the channel. A paper edge 207 needs to be completely slid over to the flat edge of the arrowhead 203 (as shown in FIG. 25 below), so that the backdoor 201 cap can then be snapped down and fully encase the paper 104a. Depending on location/destination of the display/sign and the size of the channeling employed in the frame 202 system, the frame 202 system can come with a piece of foam core (not shown), so that two sheets of paper 104a can be applied to both sides of the foam core before inserting into the channel of the frame 202 system, to improve appearance and rigidity.

FIG. 24 depicts a perspective view of the frame 202 system from behind. The paper 104a has already been fully inserted in the frame 202 system, but the backdoor 201 cap has not been swung down/closed yet. The frame 202 system channel can be created in a variety of sizes and depths depending on the weight and size of the material that will be inserted. For instance, the frame 202 system could be made large enough to hold a piece of foam core that has outside dimensions of, say, two feet wide by 1 feet high. In addition, the channel track opening could be wide enough to also allow for a transparent material (not shown) such as plexiglass or glass to strengthen the display/sign, improve appearance, and/or help weatherize the display/sign. FIG. 25 depicts the frame 202 system with the backdoor 201 cap swung down/closed.

Referring to the “H” type clip 305a in FIGS. 6-11, some of the following articles and components of embodiments of special “Strap-Lock ‘H’ Connectors’ have some structural elements similar to a U.S. Pat. No. 4,532,679 entitled Cable Tie by William J. Scott and herein entirely incorporated by reference.

FIG. 26a depicts an embodiment of a component of a particular “Strap-Lock ‘H’connector” 450 called a “H-side body” 400 which may be considered the front. The “H-side body” 400 is this embodiment example is rectangular with a passage or channel 412 through it with openings on each surface 420 and 422. FIG. 26b depicts an embodiment of the same “H-side body” 400 component, but from which may be considered the top or bottom surfaces. The “H-side body” 400 has the passage or channel 412 and is depicted with an outline 901. The channel or passage is more or less square and is made up of two 65 longitudinal or side walls 424 and 426 and two lateral or end walls, one 430 the adjacent side of the frame and the other 432 adjacent the opposite side of the frame.

FIG. 26c depicts another component of the particular “Strap-Lock ‘H’ connector” 450 called a “H-Strap” 460 from which may be considered a side view. The “H-Strap” 460 is generally an independent component and meant to travel through in one-particular direct from a head end with is the 420 surface and typically through a pair of “H-side bodies” 400a and 400b to create a locking connection.

FIG. 26d depicts an embodiment of the same “H-Strap” 460, but as a cross section down the center from which may be considered a top view. As depicted, the left end of the H-strap 460 in the head end for insertion. The H-strap 460 has ratchet teeth 430 and 432 formed on each side thereof and, as shown, they are aligned laterally as shown in FIG. 26d.

FIG. 26e depicts an embodiment of the same “H-side body” 400 component in FIGS. 26a and 26b, but as a cross section down the center from which may be considered a top view. A pair of pawls 408 and 410 arc formed inside of the passage or channel, the one 408 being on the strap side lateral wall and the other 410 on the opposite side lateral wall. The pair of pawls are formed or hinged adjacent the lower surface 422 as shown in FIG. 26b, and extend up toward the front surface on the “H-side body” 400 surface 420, and generally do not rise or stick out of the top of the “H-side body” 400 surface 420. The pair of pawls have abutments/locks or steps 402 and 406 which, in their free state, have a minimum spacing 902 which is somewhat less than the minimum strap thickness so that when the strap is inserted, the pawls will be flexed apart. The pair of pawls have inclined or dihedral entrance surfaces 434 and 436 which are formed at predetermined angles relative to the channel axis 903.

FIG. 26f depicts an embodiment of a pair of the same “H-side body” 400 components, with a top one 400a and a bottom one 400b. The pawls oppose each other and the strap is arranged to be reversely flexed and inserted through the head from a bottom upward direction in FIG. 26f and from right to left in a perspective view depicted in a FIG. 26g. The “Strap-Lock ‘H’ connector” 450 locks the 400a and 400b together around a particular centerpiece (not shown). The number of teeth, paws, and paw abutments can be more numerous and thus allow for sandwiching centerpieces with paper thin thicknesses (not shown).

In another embodiment, the ratchet teeth on one side might be staggered or offset relative to the ratchet teeth 432 on the other side. If the ratchet teeth 430, 432 and the H-strap are staggered or displaced longitudinally from each other, the steps or shoulders 402, 406 on the pawls should be also staggered or out-of-line to the same degree. In another embodiment, the ratchet teeth on one side could be in smaller increments than on the other side, thus allowing the Strap-Lock ‘H’ Connector” 450 to fit a smaller thickness on one side and vice versa and where the head structure would need to be adjusted accordingly.

FIG. 27a depicts a perspective view of another embodiment of another particular “Strap-n-Tie ‘H’ connector” 550 which is similar to the “Strap-Lock ‘H’ connector” 450. The “Strap-n-Tie ‘H’ connector” 550 also uses the same “H-side body” 400 component, but typically only one instead of two as depicted in a FIG. 27b. The angle of the head end entrance surface for the strap is similar to U.S. Pat. No. 4,532,679 entitled Cable Tic by William J. Scott in his FIG. 3. Whatever angles are used, the result is that the entrance channel or funnel is such that insertion of the head end of the strap will be guided, from down-right to up-left because the resultant entrance channel moves up to the left and tends to guide the strap in the direction of arrow 904 in FIG. 27.

FIG. 27d depicts an embodiment of a “Strap-n-Tie ‘H’ side body 500 which is similar to the “H-side body” 400, but also has a strap molded and/or adhered, similar to the H-strap 460 and as depicted with a cross section down the center from which may be considered a top view. FIG. 26c depicts the same “Strap-n-Tic ‘H’ side body 500 from which may be considered a side view.

The aforementioned examples can take an item, such as an ordinary sheet of paper and make it more presentable, with such improvements as colored borders, designs, hanging and posting methods, pre-cut shapes, tinted sleeve/overlays, laminated sides and/or sleeves, and the like, and/or some combinations of these improvements. Some units can employ sleeves, channels, hangers, corner hangers, cutout windows, transparent protruding shapes and forms for design and/or holding items, and the like.

Some units can have laminated sleeves and/or windows that can be transparent enough to read any printed text on an underlying sheet of paper or the like. The sleeve can be laminated to improve the appearance, longevity, and to help weatherize it if used outdoors. In some embodiments, the laminated sleeve would not become permanently sealed and thus reusable, or laminated in such a manner, to allow the displayed art or paper employed behind the window to still be replaceable. The center piece 181 or paper 104a could be replaced by, say, cutting it out, opening a designated end/side (e.g. bottom or side) that then allowed the paper to be removed/replaced, and/or by inserting an new center piece over the top, say through the front window, with diagonal corner flaps (not shown).

Another benefit with the invention is that the user is not forced to commit to an arrow direction until the unit is permanently laminated and perhaps never, if the unit is not permanently sealed shut on all sides. Some units can be made of thicker than paper cardstock, where shapes can be attached to create a decorative and/or functional border, say, an arrowhead shape attached on one end (not shown), or shapes that turn a 4-sided printed material into, say a star shape, person, place, thing, or the like. Attaching an arrowhead shape to a piece of foam core also allows for the display/sign/unit to be broken down into a relatively small footprint for portability.

The foregoing description of the present invention has been provided for purposes of illustration and description. It is not intended to be exhaustive or to limit the invention to the precise forms disclosed. Many modifications and variations will be apparent to the practitioner skilled in the art. Embodiments were chosen and described in order to best explain the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed:

1. A display system comprising:
a perimeter decorative shape;
a center piece attached to the perimeter decorative shape, wherein the centerpiece is interchanged.

2. A display system of claim 1, wherein the perimeter decorative shape serves a navigation purpose.

3. A display system of claim 1, wherein a hanger can be attached to the perimeter decorative shape.

4. A display system of claim 1, wherein the perimeter decorative shape includes a window.

5. A display system of claim 4, wherein the window is a protruding three-dimensional shape.

6. A display system of claim 4, wherein the window is tinted.
A display system comprising:
a channel system of a perimeter decorative shape,
encapsulating an inserted center piece, wherein the centerpiece is interchangeable.

7. A display system of claim 7, wherein the perimeter decorative shape serves a navigation purpose.

8. A display system of claim 7, wherein a hanger can be attached to the perimeter decorative shape.

9. A display system comprising:
a channel system of a perimeter decorative shape,
encapsulating an inserted center piece, wherein the centerpiece is interchangeable.

10. An three piece connector, comprising:
an elongated flexible strap, with a ratchet teeth formed on opposite sides of the strap;
a pair of frames to with an opening catch system, whereby the elongated flexible strap is passed through the opening catch system and whereby the pair of frames are drawn together via the opening catch system and the ratchet teeth formed on opposites sides of the strap.
